(19) United States
(12) Patent Application Publication
(10) Pub. No.: US 2018/0088205 A1
(43) Pub. Date: Mar. 29, 2018

(54) POSITIONING

(71) Applicant: Nokia Technologies Oy, Espoo (FI)

(72) Inventors: Durgaprasad SHAMAIN, San Jose, CA (US); Wuyuan LI, Chapel Hill, NC (US)

(21) Appl. No.: 15/279,485

(22) Filed: Sep. 29, 2016

(51) Int. Cl. G01S 5/02; H04W 4/02; H04W 4/04

(52) U.S. Cl. CPC G01S 5/0268; H04W 4/027; H04W 84/12; H04W 4/043; G01S 5/0294; H04W 4/02

(57) ABSTRACT

A method of determining a user location comprises: calculating a horizontal velocity and direction of horizontal movement of a mobile device in communication with at least one wireless access point, calculating an observed Doppler shift in a signal transmitted between the mobile device and the at least one wireless access point, calculating an expected Doppler shift in the transmitted signal based on a carrier frequency, the horizontal velocity and direction of horizontal movement, and determining a vertical position of the mobile device based on the expected Doppler shift and the observed Doppler shift. A mobile device, apparatus and positioning system for performing the method are also provided.

### FIELD

The present specification relates to a method of determining a user location, and a positioning system, wireless access point and mobile device.

### BACKGROUND

Current methods of indoor positioning include using Bluetooth™ beacons, for example for triangulating a user's location based on bearing calculations. The High Accuracy Indoor Positioning (HAIP) system developed by Nokia is an example of such a system.

Other methods include using Wi-Fi access control applications. For example, a server can determine a user's location based on the network their mobile device is currently connected to. However, this requires collaboration between all of the network providers in the system.

Generally, whether indoor or outdoor, it is relatively straightforward to determine a user's location on a horizontal plane. However, it is more difficult to also determine the user's elevation (or vertical position), particularly where GPS signal is poor.

### SUMMARY

According to a first aspect of the present specification, there is provided a method of determining a user location, comprising:
calculating a horizontal velocity and direction of horizontal movement of a mobile device in communication with at least one wireless access point;
calculating an observed Doppler shift in a signal transmitted between the mobile device and the at least one wireless access point;
calculating an expected Doppler shift in the transmitted signal based on a carrier frequency, the horizontal velocity and direction of horizontal movement; and
determining a vertical position of the mobile device based on the expected Doppler shift and the observed Doppler shift.

Advantageously, the method according to the first aspect does not require any features other than a mobile device and an access point, such as a wireless router. In other words, BLE beacons and other sensors are not necessary.

Calculating the observed Doppler shift may comprise:
measuring the frequency of a signal received by the mobile device from the wireless access point;
calculating a first difference between the frequency of the signal received by the mobile device and the frequency of a signal transmitted by the mobile device;
measuring a frequency of a signal transmitted by the at least one wireless access point;
calculating a second difference between the frequency of the signal transmitted by the at least one wireless access point and the frequency of a signal received by the wireless access point from the mobile device; and
calculating the observed Doppler shift based on the first difference and the second difference.

The method may further comprise:
calculating the observed Doppler shift according to the equation:

Δf=−(e₁+e₂)/2,

wherein Δf is the observed Doppler shift, e₁ is the first difference, and e₂ is the second difference.

A or the carrier frequency may be one of 2.4 GHz and 5 GHz.

The method may comprise:
calculating the observed Doppler shift in a plurality of signals transmitted between the mobile device and a plurality of wireless access points, wherein each signal is associated with a corresponding one of the plurality of wireless access points; and
deducing the position of the mobile device based on the expected Doppler shift and the plurality of observed Doppler shifts.

The method may comprise:
calculating the observed Doppler shifts at each of the corresponding wireless access points;
transmitting the Doppler shift observed at the plurality of wireless access points to a server; and
calculating the vertical position of the mobile device at the server.

The method may comprise:
calculating the vertical position of the mobile device at the at least one wireless access point; and
transmitting the calculated vertical position to at least one of a server, mobile device, and display apparatus.

The method may comprise receiving an identifier of the mobile device, and transmitting the calculated vertical position to the mobile device based on the identifier.

The method may comprise converting the calculated vertical position of the mobile device to a floor number.

The method may comprise displaying the vertical position of the mobile device.

The mobile device may be determined to be at the same vertical position as the at least one wireless access point if the observed Doppler shift is greater than a threshold, and the mobile device may be determined to be at a different vertical position to the wireless access point if the observed Doppler shift is less than a the threshold, wherein the threshold is based on the expected Doppler shift.

According to a second aspect of the present specification, there is provided a mobile device comprising:
a receiver configured to receive a signal from at least one wireless access point;
a controller configured to:
   measure the frequency of the received signal; and
   calculate the difference between the frequency of the received signal and the frequency of a signal transmitted by the mobile device; and
a transmitter configured to transmit the difference to the at least one wireless access point.

The transmitter may be further configured to transmit an identifier for identifying the mobile device to the at least one wireless access point.

The receiver may be further configured to receive a vertical position of the mobile device from one of a server and the at least one wireless access point; and the apparatus may further comprise a display for displaying the vertical position.

According to a third aspect of the present specification, there is provided an apparatus comprising:
a transceiver configured to transmit and receive a wireless signal to and from a mobile device;
a controller configured to perform the steps of:
   obtaining a horizontal velocity and direction of horizontal movement of a mobile device;
   calculating an observed Doppler shift in a signal transmitted between the mobile device and the apparatus;
   calculating an expected Doppler shift in the transmitted signal based on a carrier frequency, the horizontal velocity and direction of horizontal movement; and
   determining a vertical position of the mobile device based on the expected Doppler shift and the observed Doppler shift.

The transceiver may comprise a receiver configured to receive a first difference in frequency between a signal received by the mobile device and a signal transmitted by the mobile device; and
the controller may be further configured to:
   measure a frequency of a signal received by the apparatus from the mobile device;
   calculate a second difference between the frequency of the signal received by the apparatus and the frequency of a signal transmitted by the apparatus; and
   calculate the observed Doppler shift based on the difference between the first difference and the second difference.

The controller may be further configured to:
calculate the observed Doppler shift according to the equation:

Δf=−(e₁+e₂)/2,

wherein Δf is the observed Doppler shift, e₁ is the first difference, and e₂ is the second difference.

The controller may be configured to determine the mobile device to be at the same vertical position as the apparatus if the observed Doppler shift is greater than a threshold, and determine the mobile device to be at a different vertical position to the apparatus if the observed Doppler shift is less than a the threshold, wherein the threshold is based on the expected Doppler shift.

The apparatus may be an IEEE 802.11 compliant access point.

The apparatus may further comprise a wired or wireless interface for transmitting the vertical position of the mobile device to the mobile device or to a server.

According to a fourth aspect of the present specification, there is provided a positioning system comprising the mobile device according to the second aspect and one or more apparatuses according to the third aspect, and the system being configured to perform the steps according to the first aspect.

The positioning system may further comprise a server configured to receive one of an observed Doppler shift from the one or more apparatuses, a difference in frequency between a signal transmitted by a mobile device and a signal received by the mobile device and a difference in frequency between a signal transmitted by an apparatus and a signal received by the apparatus, and a vertical position of the mobile device from the one or more apparatuses, wherein, if the observed Doppler shift is received or if the difference in frequencies are received, the server is configured to calculate the vertical position of the mobile device.

The positioning system may further comprise a display device for displaying the vertical position of the mobile device.

According to a fifth aspect of the present invention, there is provided a computer-readable storage medium having computer-readable code stored thereon, the computer-readable code, when executed by at least one processor, causing performance of:
calculating a horizontal velocity and direction of horizontal movement of a mobile device in communication with at least one wireless access point;
calculating an observed Doppler shift in a signal transmitted between the mobile device and the at least one wireless access point;
calculating an expected Doppler shift in the transmitted signal based on a carrier frequency, the horizontal velocity and direction of horizontal movement; and
determining a vertical position of the mobile device based on the expected Doppler shift and the observed Doppler shift.

The computer-readable storage medium having computer-readable code stored thereon, the computer-readable code, when executed by at least one processor, may cause performance of:
measuring the frequency of a signal received by the mobile device from the wireless access point;
calculating a first difference between the frequency of the signal received by the mobile device and the frequency of a signal transmitted by the mobile device;
measuring the frequency of a signal transmitted by the at least one wireless access point;
calculating a second difference between the frequency of the signal transmitted by the at least one wireless access point and the frequency of a signal received by the wireless access point from the mobile device; and
calculating the observed Doppler shift based on the first difference and the second difference.

The computer-readable storage medium according to claim 13 having computer-readable code stored thereon, the computer-readable code, when executed by at least one processor, may cause performance of:
calculating the observed Doppler shift according to the equation:

Δf=−(e₁+e₂)/2,

wherein Δf is the observed Doppler shift, e₁ is the first difference, and e₂ is the second difference.

The mobile device may be determined to be at the same vertical position as the at least one wireless access point if the observed Doppler shift is greater than a threshold, and wherein the mobile device may be determined to be at a different vertical position to the wireless access point if the observed Doppler shift is less than the threshold, wherein the threshold is based on the expected Doppler shift.

According to a sixth aspect of the present invention, there is provided an apparatus comprising:
at least one computer processor; and
at least one memory having computer-readable instructions stored thereon, the computer-readable instructions when executed by the at least one processor causing the apparatus at least to:
obtain a horizontal velocity and direction of horizontal movement of a mobile device;
calculate an observed Doppler shift in a signal transmitted between the mobile device and the apparatus;
calculate an expected Doppler shift in the transmitted signal based on the horizontal velocity and direction of horizontal movement; and
determine a vertical position of the mobile device based on the expected Doppler shift and the observed Doppler shift.

The computer-readable instructions may cause the apparatus at least to:
receive a first difference in frequency between the signal received by the mobile device and a signal transmitted by the mobile device;
measure a frequency of a signal received by the apparatus from the mobile device;
calculate a second difference between the frequency of the signal received by the apparatus and the frequency of a signal transmitted by the apparatus; and
calculate the observed Doppler shift based on the difference between the first difference and the second difference.

The computer-readable instructions may cause the apparatus at least to:
calculate the observed Doppler shift according to the equation:

Δf=−(e₁+e₂)/2,

wherein Δf is the observed Doppler shift, e₁ is the first difference, and e₂ is the second difference.

The computer-readable instructions may cause the apparatus at least to:
determine the mobile device to be at the same vertical position as the apparatus if the observed Doppler shift is greater than a threshold, and determine the mobile device to be at a different vertical position to the apparatus if the observed Doppler shift is less than a the threshold, wherein the threshold is based on the expected Doppler shift.

The apparatus may be an IEEE 802.11 compliant access point.

All features described herein (including any accompanying claims, abstract and drawings), and/or all of the steps of any method or process so disclosed, may be combined with any of the above aspects in any combination, except combinations where at least some of such features and/or steps are mutually exclusive.

### BRIEF DESCRIPTION OF THE FIGURES

Embodiments of the present specification will now be described, by way of example only, with reference to the accompanying drawings, in which:

FIG. 1 is a schematic diagram of a positioning system according to embodiments of the present specification;

FIGS. 2a and 2b are schematic diagrams illustration how the position of a mobile device is determined according to embodiments of the present specification;

FIG. 3 is a schematic diagram illustrating a building having a positioning system according to embodiments of the present specification;

FIG. 4 is a graph showing how the position of a mobile device in the vertical plane is determined according to an aspect of the present specification;

FIG. 5 is a flow chart illustrating operation of a mobile device according to embodiments of the present specification;

FIG. 6 is a flow chart illustrating operation of an access point according to embodiments of the present specification;

FIG. 7 is a system diagram of a system for triangulating the position of a mobile device according to embodiments of the present specification;

FIG. 8 is a schematic diagram illustrating a building having a positioning system according to embodiments of the present specification;

FIG. 9 is a flow chart illustrating operation of a server according to embodiments of the present specification;

FIG. 10 is a flow chart illustrating operation of a server according to another embodiment of the present specification; and

FIG. 11 is a schematic diagram illustrating a storage medium according to an aspect of the present specification.

### DETAILED DESCRIPTION

In the description and drawings, like reference numerals refer to like elements throughout.

The present invention relates to calculating the vertical position of a mobile device 210. This is particularly useful in buildings having multiple floors, where it is helpful to keep track of employees or customers. The invention described herein makes use of wireless access points 290, such as commercial-off-the-shelf Wi-Fi routers, but any wireless standard with a known carrier frequency may be used. The Doppler shift that would be expected if the mobile device 210 and access point 290 were on the same level (i.e. the same or substantially the same horizontal plane) is calculated using the horizontal velocity of the mobile device. The actual observed Doppler shift is then calculated by comparing transmitted and received signals with the carrier frequency. The vertical position of the mobile device 210 is then inferred by comparing the expected Doppler shift with the observed Doppler shift.

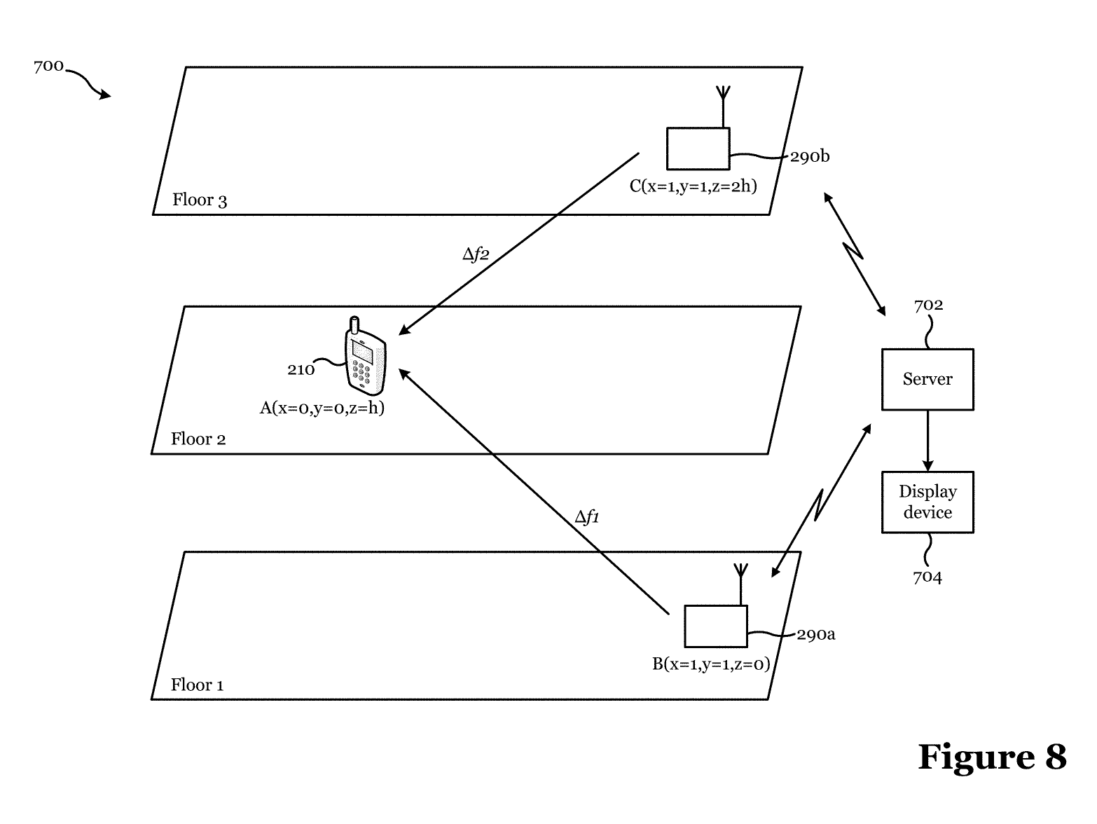

In some embodiments, the mobile device 210 determines its own vertical position. In other embodiments, the access points 290 determine the mobile device's 210 vertical position. Finally, a server 702 (shown in FIG. 8) coupled to the access points 290 may calculate the vertical position of the mobile device 210.

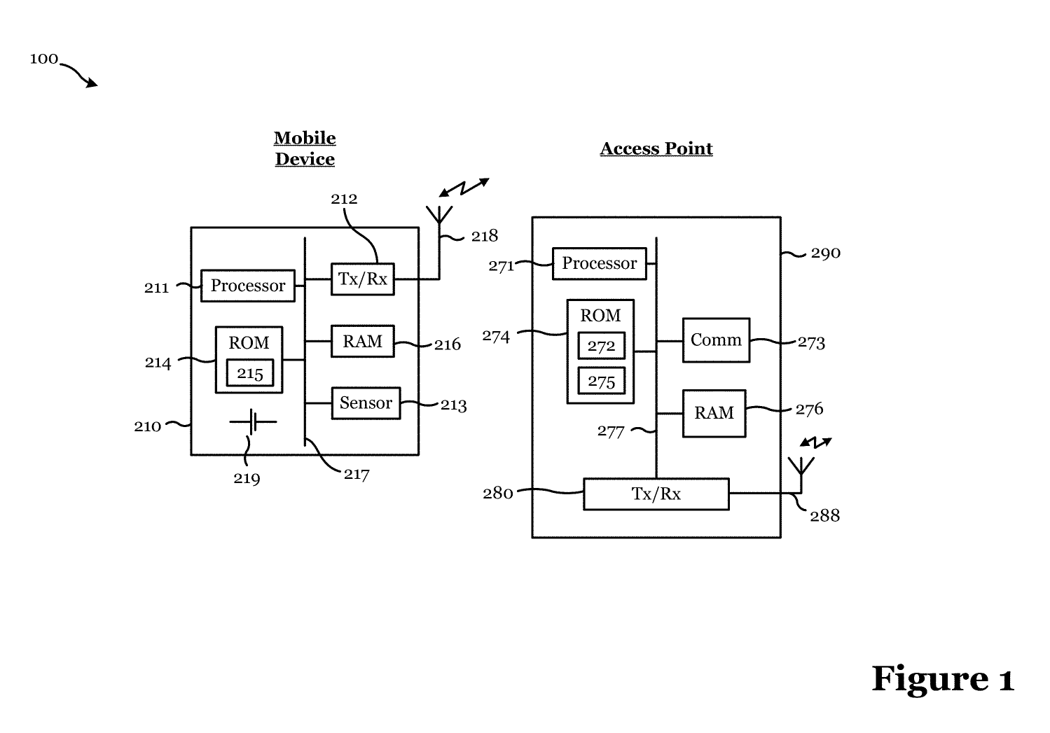

FIG. 1 shows a system 100 according to embodiments of the present specification. The system 100 includes a mobile device 210 and an access point 290. The mobile device 210 is portable and its location can be tracked. For example, the mobile device 210 is a mobile tag, a mobile phone, a tablet or a laptop. The access point 290 according to some embodiments is a wireless access point, for example a Wi-Fi access point.

The mobile device 210 includes a transceiver module 212, which operates according to the IEEE 802.11 standard. The mobile device 210 in these embodiments is able to communicate with the access point 290 through an IEEE 802.11 standard protocol, such as 802.11b/g/n. The transceiver module 212 is capable of receiving and/or transmitting wireless signals with a frequency of 2.4 GHz and/or 5 GHz. In some embodiments, the transceiver module 212 is also configured to operate according to other communication standards, for example where the mobile device 210 is a mobile phone, so that it can communicate with devices other than the access point 290. These other communication standards may include BTLE, GSM, EDGE and LTE.

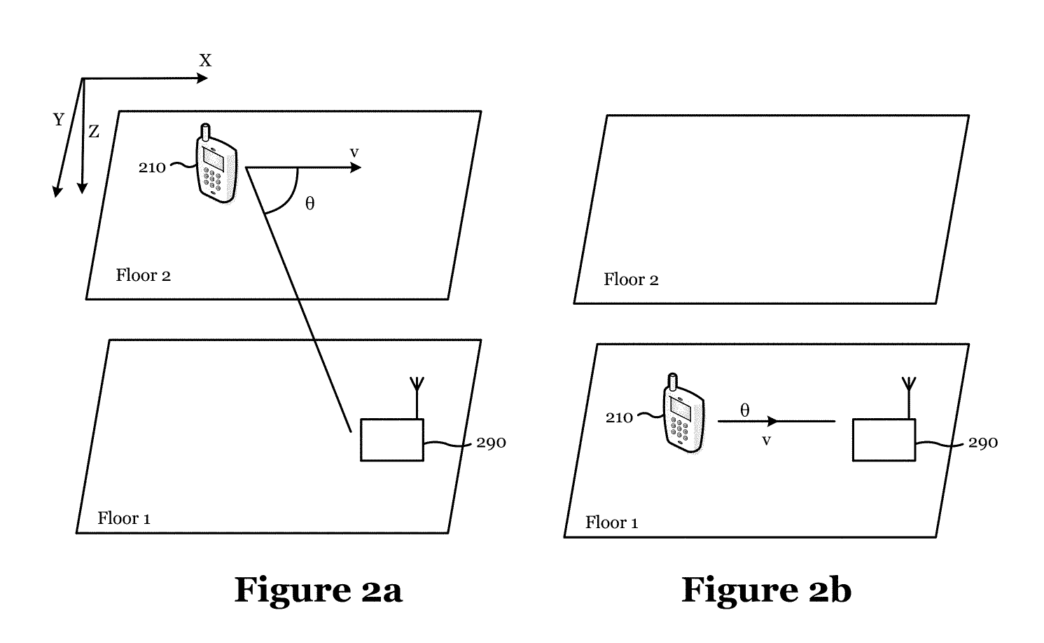

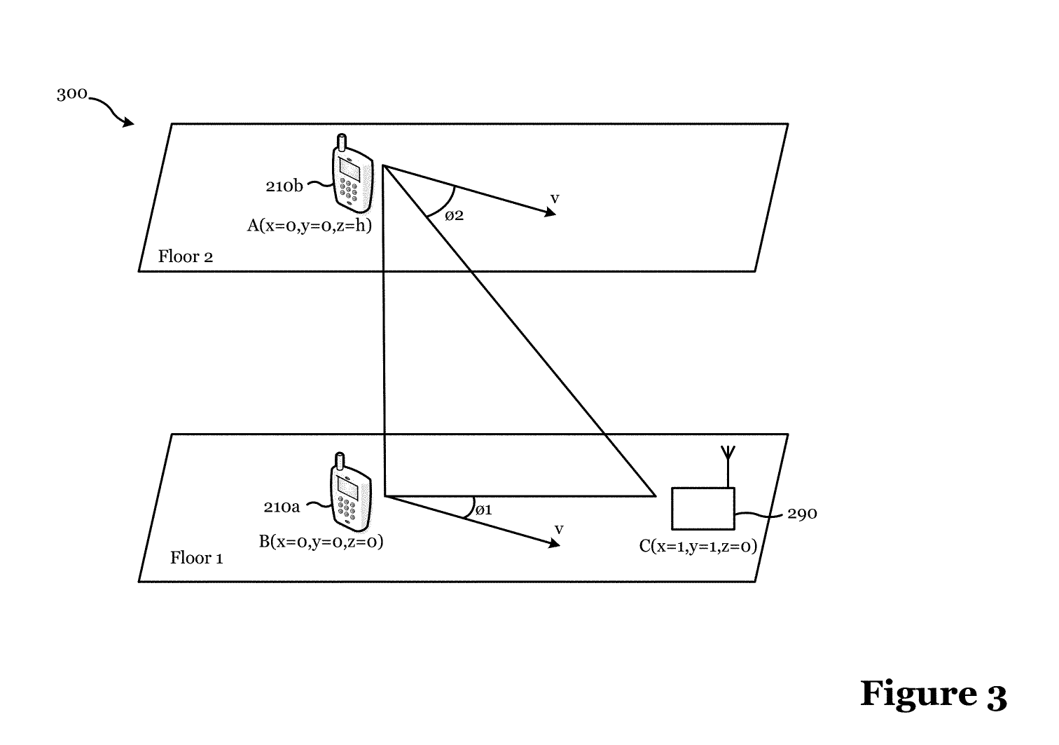

The mobile device 210 includes a processor 211. The processor 211 is connected to volatile memory such as RAM 216 by a bus 217. The bus 217 also connects the processor 211 and the RAM 216 to non-volatile memory, such as ROM 214. The transceiver module 212 is coupled to the bus 217, and thus also to the processor 211 and the memories 214, 216. An antenna 218 is coupled to the transceiver module 212. While the antenna 218 is shown as being external to the mobile device 210, in some embodiments the antenna 218 is internal to the mobile device 210. Within the ROM 214 is stored a software application 215. The function of the software application 215 will be described with reference to FIGS. 2a, 2b and 3, in which it will be explained how the location of the mobile device 210 is determined.

The mobile device 210 also includes a power source 219. The power source 219 may be for instance a battery such as a coin cell. The power source 219 powers the transceiver module 212 and any other components of the mobile device 210. The mobile device 210 may optionally include a sensor 213 for detecting movement of the mobile device 210. The sensor 213 may take the form of a tilt switch or accelerometer, for instance.

The mobile device 210 may take any suitable form. Generally speaking, the mobile device 210 may comprise processing circuitry 211, including one or more processors, and a storage device 214, 216, comprising a single memory unit or a plurality of memory units. The storage device 214, 216 may store computer program instructions 215 that, when loaded into the processing circuitry 211, control the operation of the mobile device 210.

The transceiver module 212 may take any suitable form. Generally speaking, the transceiver module 212 of the mobile device 210 may comprise processing circuitry, including one or more processors, and a storage device comprising a single memory unit or a plurality of memory units. The storage device may store computer program instructions that, when loaded into the processing circuitry, control the operation of the transceiver module 212.

The transceiver module 212 includes a communication stack that is implemented at least partly in software using processor and memory resources (not shown), all of which are included within the transceiver module 212. The transceiver module 212 is configured, when enabled by the processor 211 running application 215, to transmit information on a signal according to the IEEE 802.11 standard. The information on the signal may include an identifier of the mobile device 210. The information on the signal may also include the mobile device's horizontal velocity. Alternatively or additionally, the access point 290 or a server is used to determine the mobile device's horizontal velocity. Furthermore, the transceiver module 212 is also configured to receive signals according to the IEEE 802.11 standard and measure accurately their frequency. This will be discussed in more detail later.

The transceiver module 212 of the mobile device 210 is both a transmitter and a receiver. However, while the transceiver module 212 is configured to receive a wireless signal according to the IEEE 802.11 standard, it may not be configured to transmit a signal according to the IEEE 802.11 standard. Instead, in these embodiments, the transceiver module 212 may be configured to transmit a signal according to any suitable communication standard.

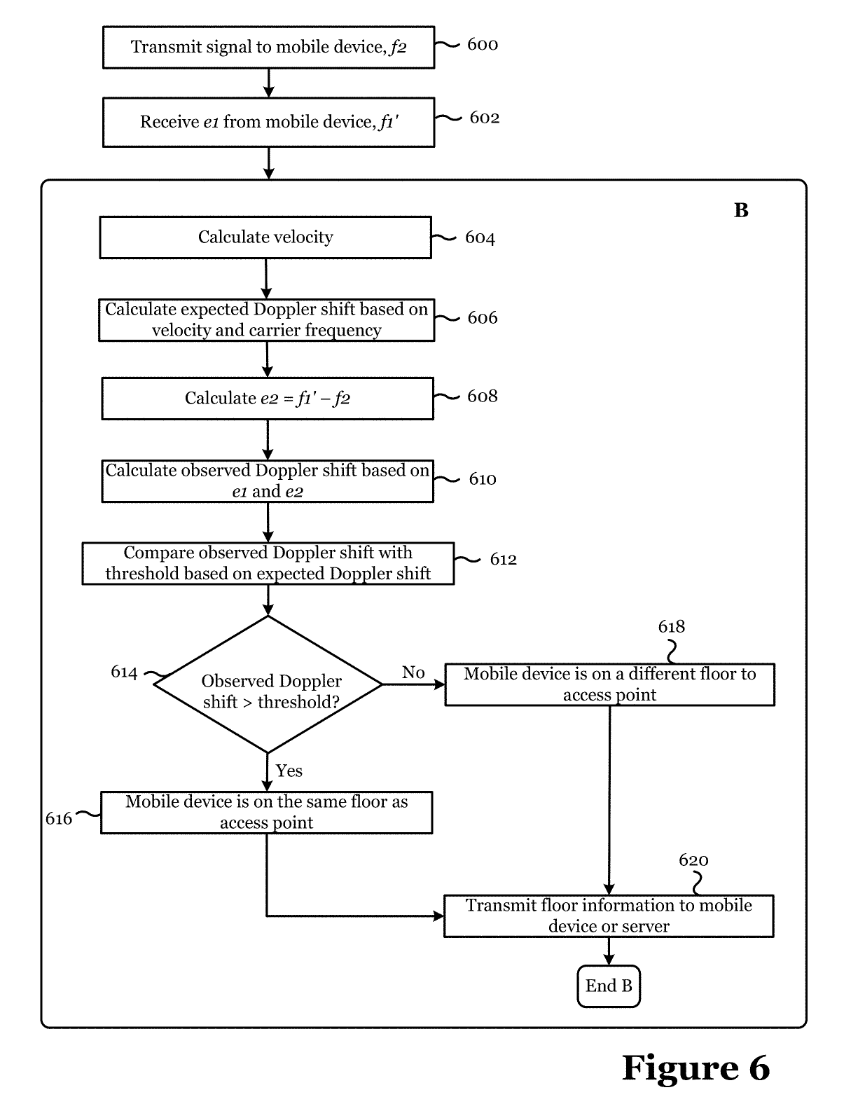

The access point 290 includes a processor 271. The processor 271 is connected to volatile memory such as RAM 276 by a bus 277. The bus 277 also connects the processor 271 and the RAM 276 to a non-volatile memory, such as ROM 274. A software application 275 is stored within the ROM 274. The software application 275 will be described in more detail with reference to FIG. 6. The access point 290 also has a communication interface 273 connected to the processor 271 via a bus 277.

The communication interface 273 may be configured to allow two-way communication with external devices and/or networks. The communication interface 273 may be configured to communicate wirelessly via one or more of several protocols such as Global System for Mobile Communications (GSM), Code Division Multiple Access (CDMA) and Universal Mobile Telecommunications System (UMTS). Alternatively or additionally, the communication interface 273 may be configured for wired communication with a device or network.

In some embodiments, the communication interface 273 sends information identifying the calculated vertical position of the mobile device 210 to a terminal device (704, in FIG. 8) for display of the position of the mobile device 210 when requested. Alternatively or in addition, the communication interface 273 sends information identifying the calculated vertical position of the mobile device 210 to the mobile device 210 for display.

The access point 290 has a transceiver 280 connected to an antenna 288. The transceiver 280 thus is configured to transmit a Wi-Fi signal to the mobile device 210. The transceiver 280 may also be configured to receive a signal from the mobile device 210. The signal received at the access point 290 may be a Wi-Fi signal. In some embodiments, the access point 290 then forwards information decoded from the Wi-Fi signal to a server for processing. The information may be forwarded to the server through a wired or wireless interface, such as through the transceiver 280 or another messaging means.

As Wi-Fi signals are used to calculate the position of the mobile device 210, the use of a wired network is not essential. However, the use of a wired network may be advantageous in embodiments having a server, as will be described in more detail with reference to FIG. 8. Further, as the calculation is done within the access point 290, the computing burden on the processor 211 of the mobile device 210 is significantly reduced, thereby extending the battery life of the power source 219 of the mobile device 210.

Wi-Fi signals may be transmitted by the access point 290 to the mobile device 210 periodically, for instance at 4 Hz (250 millisecond intervals) or at intervals defined by some component within the system 100. The Wi-Fi signals may alternatively be transmitted on request of some component within the system 100.

The mathematical derivation for calculating the vertical position of a mobile device 210 will now be described with reference to the system shown in FIGS. 2a, 2b and 3. Although these calculations will be described as being carried out at the access point 290, in other embodiments, some of the calculations are performed on a server or on the mobile device 210. In other words, in embodiments described herein, the access point 290 is used to determine the location of a mobile device 210. However, the skilled person would readily appreciate that the mobile device 210 in other embodiments uses signals received from the access point 290 to locate itself with respect to the access point 290.

FIGS. 2a and 2b each represent the same building having two floors, such as a shopping centre. There may be more than two floors in the building. Furthermore, it would be readily appreciated that the system may alternatively be employed in an outdoor environment, such as a mountain. Here, the two floors represent two levels, such as two locations at different altitudes on the mountain.

While only one access point 290 is shown, in other embodiments there are a plurality of access points 290. For example, to accurately locate the mobile device 210, there may be an access point 290 disposed on each of the floors.

In the example in FIG. 2a, the mobile device 210 is positioned on the second floor, while the access point 290 is positioned on the first floor. The access point 290 is static, while the mobile device 210 can move in the horizontal (i.e. XY) plane, and between floors (i.e. in the vertical or Z direction). In the example shown in FIG. 2a, the mobile device 210 is moving with a velocity v.

The imaginary line connecting the mobile device 210 to the access point 290, or, in other words, the shortest distance between the mobile device 210 and the access point 290, makes an angle θ with respect to the direction of travel of the mobile device 210. As shown in the example in FIG. 2b, where the mobile device 210 is on the same floor as the access point 290 the angle θ is 0 degrees.

The access point 290 transmits a Wi-Fi signal on a carrier frequency f_{c} which is received by the mobile device 210.

The formula for Doppler shift of signals transmitted between the mobile device 210 and the access point 290 is then

$$Δ f = cos θ \frac{v}{c} {f}_{c} ,$$

where c is me speed or light.

The velocity of the mobile device 210 in the horizontal plane can be calculated by any suitable means. Preferably, the access point 290 calculates how the XY coordinates (or polar coordinate, or latitude/longitude) of the mobile device 210 change with time. This may be achieved using triangulation of bearings using multiple access points 290 or a MIMO access point. Time-of-arrival and direction-of-arrival of signals may also be used to calculate how the horizontal position of the mobile device 210 changes with time. Alternatively, the mobile device 210 can calculate its own velocity, for example using the sensor 213 or a GPS receiver (not shown).

The Δf observed in the example of FIG. 2a, where the mobile device 210 and access point 290 are on the same floor, is significantly smaller than in the example of FIG. 2b. In FIG. 2b, the mobile device 210 and access point 290 are on the same floor. When the mobile device 210 and access point 290 are on the same floor, cos θ is close to or equal to 1, so the Doppler shift can be estimated to be

$$\frac{v}{c} {f}_{c} .$$

Comparing the expected, or estimated, Doppler shift to the actual observed Doppler shift allows the access point 290 to determine whether the mobile device 210 is on a different floor.

Further details of this mathematical derivation will now be described with reference to FIG. 3. Here, it is unknown to the access point 290 which of the floors (Floor 1 or Floor 2) the mobile device 210 is on, but the mobile device's 210 XY position is known. For example, the mobile device 210 is at position (0, 0) on the XY plane. Therefore, the mobile device 210 could either be at position A or position B. The mobile device 210 is moving in direction v, and the moving direction v is known to the system.

Meanwhile, there is an access point 290 on Floor 1 at point C. Point C is at XYZ coordinates (1, 1, 0). The Doppler shift in the same-floor case is then

$$Δ {f}^{′} = cos φ 1 \frac{v}{c} {f}_{c} ,$$

wherein Ø1 is the angle between v and BC. As these are known values, the expected Doppler shift can be calculated.

However, the actual Doppler shift observed by the access point 290 depends on the user's floor. For example, if the user is on Floor 2, the angle between v and AC is Ø2>Ø1. Therefore, the observed Doppler shift is

$$Δ {f}^{′} = cos φ 2 \frac{v}{c} {f}_{c} , < Δ {f}^{′} = cos φ 1 \frac{v}{c} {f}_{c} .$$

The method for calculating the observed Doppler shift, based on signal analytics, will be described later.

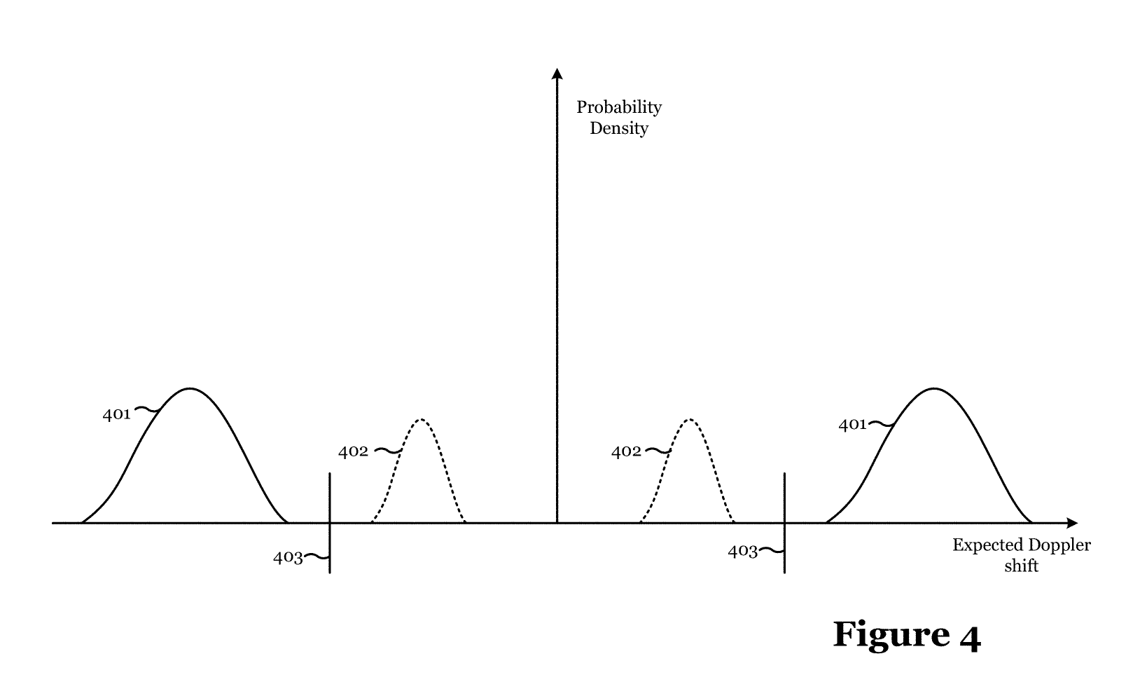

The observed Doppler shift Δf being less than the expected Doppler shift Δf′ does not automatically mean that the mobile device 210 and the access point 290 are on different floors. For example, there may be a discrepancy because of imperfect Doppler shift measurement, inaccuracies in velocity or horizontal position measurement, or because the mobile device 210 is being held at a high height by the user. Therefore, in some embodiments a threshold is set as a fraction of the expected Doppler shift and used to determine whether the mobile device 210 and the access point 290 are on different floors. As the error grows with increased velocity of the mobile device 210, the threshold frequency value (i.e. fraction of expected Doppler shift) in some embodiments is a function of velocity in order to compensate for the increasing error. This is shown in more detail in FIG. 4.

FIG. 4 shows a graph of expected Doppler shift against probability density, where there is an estimation of errors for velocity and cos φ1. The expected Doppler shift is the Doppler shift calculated based on the horizontal velocity of the mobile device 210. In other words, the expected Doppler shift is the Doppler shift that would be expected if the mobile device 210 and access point 290 are on the same floor. As can be seen from FIG. 4, when the expected Doppler shift is high, a relatively low threshold frequency value 403 is set for use in determining whether the mobile device 210 and access point 290 are on the same or different floors.

If the velocity and horizontal position, and the floor height, are accurately known, the expected Doppler shift can be perfectly estimated for the motion on both floors. The bell-shape in FIG. 4 is an indication that the measurement is an inherently noisy process. There is a symmetry about the Y-axis which indicates that the same magnitude of quantities but with a different sign is observed in the cases of moving towards an access point 290 or moving away from an access point 290.

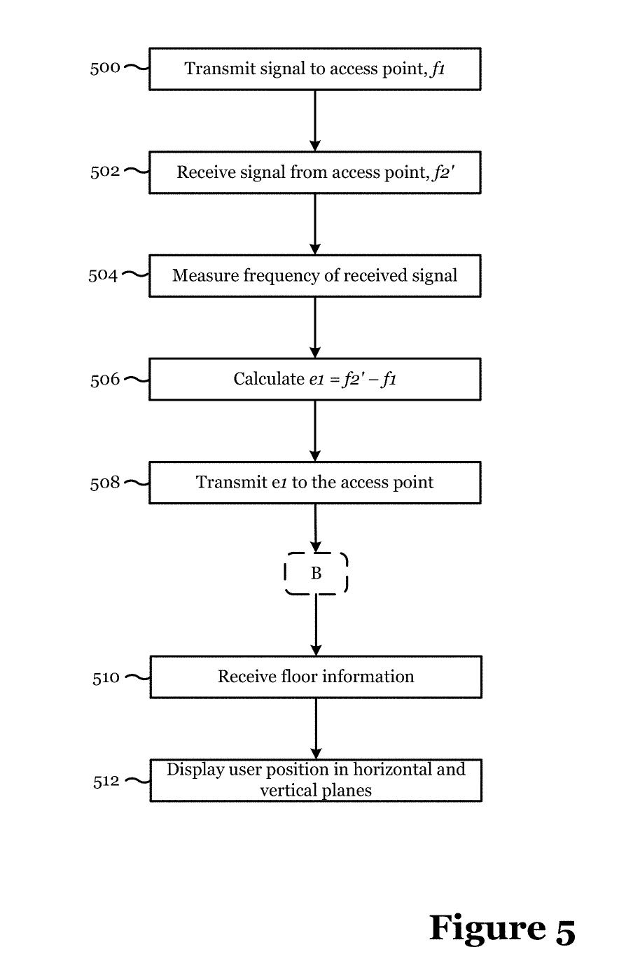

The operation of the mobile device 210 according to some embodiments will now be described with reference to FIG. 5. The transceiver module 212 of the mobile device 210 must be switched on. In a first step 500, the mobile device 210 transmits a signal to an access point 290. The frequency of this signal as measured at the mobile device 210 is designated f1. The frequency of the same signal as measured at the mobile device 210 and at the access point 290 will naturally be fractionally different, due to imperfect circuitry, attenuation in the antennas 218, 288, atmospheric conditions, errors in calculation and the Doppler shift caused by movement of the mobile device 210. The Doppler shift, which here is the observed or measured Doppler shift, would be the same value as measured at both the mobile device 210 and the access point 290.

Preferably, the signal transmitted by the mobile device 210 is a Wi-Fi signal having a carrier frequency of 2.4 GHz or 5 GHz. Current Wi-Fi protocol requires a frequency stability of 25 ppm (802.11b) or less, which means there could be a frequency shift of up to 60 kHz for 2.4 GHz Wi-Fi devices due to imperfect circuits. Meanwhile, adults typically walk at 1.4 m/s or less, which speed induces a 11.2 Hz Doppler frequency shift.

In step 502, the mobile device 210 receives a signal from an access point 290. The mobile device 210 may have a “wake up on LAN” feature, whereby receiving a wireless signal turns on the mobile device 210 fully. Alternatively, only the transceiver module 212 and the processor 211 may be powered. The mobile device 210 may transmit a request to the access point 290 for a signal prior to the signal being received. Alternatively, the access point 290 may transmit signals continuously, or at a predetermined period.

At step 504, the mobile device 210 measures the frequency of the received signal. This frequency is designated f2′. A component of the received signal frequency f2′ will be the observed Doppler shift as previously described. As the access point 290 is an access point operating according to the IEEE 802.11 standard, it would be expected that the received signal would have a frequency close to the carrier frequency of 2.4 GHz or 5 GHz. In other embodiments, where the access point 290 operates according to a different wireless standard, the carrier frequencies will be different to 2.4 GHz and 5 GHz.

At step 506, the mobile device 210 calculates the difference between the frequency of the signal transmitted by the mobile device 210, f1, and the frequency of the signal received by the mobile device 210, f2′. This difference in frequency, as measured at the mobile device 210, is designated e1.

In step 508, the transceiver module 212 transmits e1 to the access point 290. In other embodiments, the transceiver module 212 transmits e1 to a server.

The access point 290 then performs processing to determine the vertical position of the mobile device 210. The vertical position can be used to determine vertical position information such as floor information, such as the floor number in a building on which the mobile device 210 is positioned. The process, B, carried out by the access point 290 will be described later with reference to FIG. 6.

At step 510, the vertical position information is received from the access point 290 at the mobile device 210. In step 512, the vertical position information is displayed along with the horizontal position (i.e. the mobile device's 210 position on the XY plane). The horizontal position may be calculated by the mobile device 210 itself, or received from the access point 290. The display of the vertical position information and the horizontal position may take the form of a map.

Embodiments of the present disclosure may be applied to an augmented reality environment. Here the mobile device 210 may additionally be equipped with a camera which is able to capture images of the area covered by the mobile device 210. The mobile device 210 overlays these images with tags based on the vertical and horizontal position information obtained from the access point 290 or server 702. This presents the user with a stream of images as the mobile device 210 is held by the user. For example, using the vertical position information, the mobile device 210 is able to determine that the user is positioned on the second floor of a building. The mobile device 210 is then able to overlay the names of shops in the user's vicinity, based on the determined horizontal position information, or display a marker indicating a shop selected by the user as their destination.

It would be readily appreciated that steps 510 and 512 are optional steps. These steps are carried out when the user of the mobile device 210 is lost or is trying to find a route to a particular shop, for example. In other embodiments, the vertical position information is transmitted to a server for display at an external display apparatus, or stored in order to perform analytics such as human traffic management.

The process carried out by the access point 290 will now be described with reference to FIG. 6. In a first step, step 600, the access point 290 transmits a signal to the mobile device 210. Preferably, the signal is a Wi-Fi signal having a carrier frequency of 2.4 GHz or 5 GHz. The frequency of the transmitted signal, as measured at the access point 290, is designated f2. Next, in step 602, the access point receives e1 in a signal received from the mobile device 210. e1 was calculated by the mobile device 210 in step 506 described with reference to FIG. 5. The frequency of the signal containing e1 is then measured, and the frequency of the received signal, as measured at the access point 290 is designated f1′.

The access point 290 suffers from the same problems as the mobile device 210, such as imperfect circuits and signal attenuation. One component of f1′, as with f2′, is the observed Doppler shift, which will have the same value in both cases.

Process B, as shown in FIG. 5, will now be described with reference to steps carried out by the access point 290.

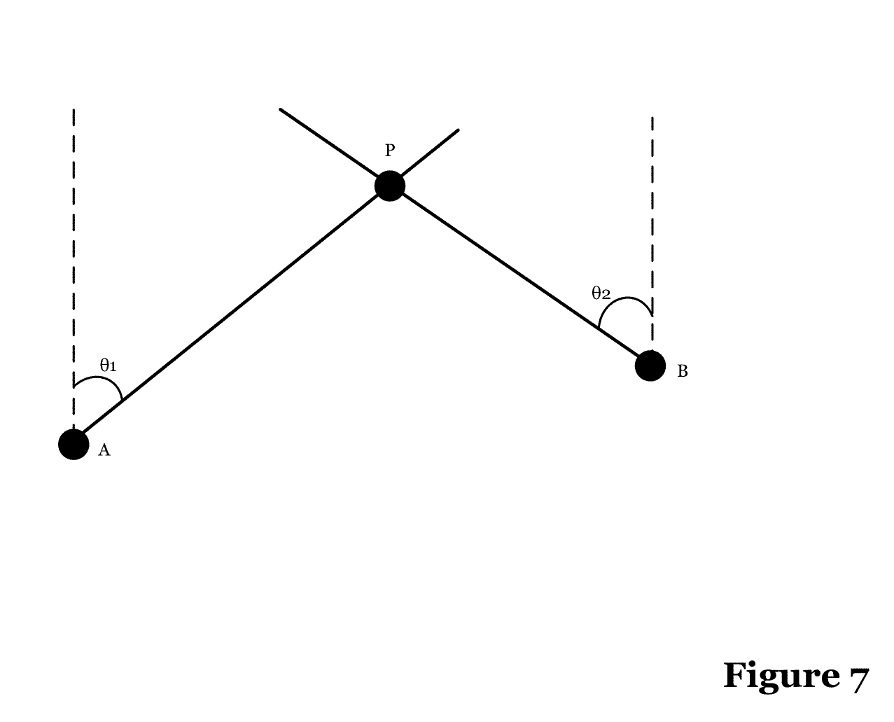

In step 604, the access point 290 calculates the horizontal velocity of the mobile device 210. The horizontal velocity includes the direction in which the mobile device 210 is moving. The horizontal velocity is calculated based on how the horizontal position (such as XY coordinates, polar coordinates, or latitude and longitude) changes with time. One example of a means to calculate the changing horizontal position will be described with reference to FIG. 7. Here, triangulation is used. Horizontal velocity may also be calculated by obtaining the horizontal position of the mobile device 210 from the mobile device 210 itself, and calculating how the horizontal position changes with time. The mobile device 210 may determine its horizontal position using GPS.

Alternatively again, the following techniques could be used to determine the horizontal position of the mobile device 210: coarse localization using the time-of-arrival/time direction-of-arrival of a signal using multiple access points 290; and 2D accurate static device localization using both time-of-arrival and direction-of-arrival of a signal using one access point 290. Since these coordinates are available at a fine time granularity (for example 250 millisecond), their rate of change, such as velocity and acceleration, can also be obtained.

The expected Doppler shift of the mobile device 210 is then calculated in step 606 based on the horizontal velocity and the carrier frequency. The expected Doppler shift is calculated using the equation

$$φ 1 \frac{v}{c} {f}_{c} .$$

To account for inaccuracies in the measurement, a tolerance is added to the measurement in some embodiments.

In step 608, the access point 290 calculates the difference in frequency between the signal transmitted by the access point 290 and the signal received by the access point 290 from the mobile device 210, as measured at the access point 290. In other words, the access point calculates e2=f1′−f2.

At step 610, the observed Doppler shift is calculated at the access point 290. As the Δf component of e1 and e2 is the same in both, Δf can then be calculated according to the equation

$$Δ f = \frac{- ( {e}_{1} + {e}_{2} )}{2} .$$

This is the observed Doppler shift, as measured at the access point 290.

It would be readily appreciated by the skilled person that the order of steps 600 to 610 can be reversed while still providing the same advantages over the prior art. Particularly, the calculating the observed Doppler shift in step 610 can be performed before the expected Doppler shift is calculated in step 606.

At step 612, the observed Doppler shift is compared with a threshold frequency value based on the expected Doppler shift. More specifically, the threshold frequency value is a fraction of the expected Doppler shift, such as 90% of the expected Doppler shift. The threshold value depends on the configuration of the building in which the system is implemented. For example, the threshold depends on the height of each floor, or the material from which ceilings are made.

At step 614, it is determined whether the observed Doppler shift is greater than or less than the threshold frequency value. If the observed Doppler shift is greater than the threshold frequency value, then it is determined that the mobile device 210 and the access point 290 are at the same vertical position in step 616. In other words, the mobile device 210 and access point 290 are determined to be on the same floor if the expected Doppler shift and observed Doppler shift are significantly similar.

If the observed Doppler shift is less than the threshold frequency value, then it is determined that the mobile device 210 and the access point 290 are at different vertical positions to each other in step 618. In other words, the mobile device 210 and access point 290 are on the different floors if the expected Doppler shift and observed Doppler shift are not the same, or significantly different.

The vertical position information, such as a predicted floor number or a range of elevation, is then transmitted to the mobile device 210 or a server for storage or display in step 620. In some embodiments, the access point 290 comprises a memory 274 for storing a lookup table. The lookup table is read by the processor 271 to convert the vertical position of the mobile device 210 to a floor number.

It would be readily appreciated that in alternative embodiments e1 and e2 may be transmitted to a server through a wired or wireless connection for processing, and here the server calculates the observed Doppler shift Δf. Furthermore, the server may carry out steps 610 to 618. Moreover, it would also be appreciated that steps 610 to 620 could be carried out on the mobile device 210 when the access point is configured to transmit e2 to the mobile device 210.

FIG. 7 is a system diagram showing one method of calculating the horizontal position of the mobile device 210. Measuring how the horizontal position changes with time (i.e. between t1 and t2) provides the horizontal velocity and direction of travel of the mobile device 210.

The system requires at least two access points 290, located at positions A and B. Here, the access points 290 are multiple in multiple out (MIMO) access points. The mobile device 210, which transmits a signal that can be received by both access points 290, is positioned at point P.

The two or more access points 290 measure the direction-of-arrival of an incoming signal from the mobile device 210 to estimate a bearing line to the mobile device 210 from each access point 29. The point where these bearing lines cross is used as an estimation of the mobile device 210 location. In other words, the horizontal position of the mobile device 210 is triangulated using a plurality of access points 290.

Where there are more than two floors in a building, it is difficult to determine the exact floor the user is on when there is only one access point 290. The access point 290 is able to determine whether or not the mobile device 210 is on the same floor, or whether it is not on the same floor. Therefore, as shown in FIG. 8, a plurality of access points 290a, 290b can be used to deduce the vertical position of the mobile device 210.

In the example shown in FIG. 8, the first access point 290a is disposed on a lower floor, such as a ground floor, with a vertical position 0 in the z direction. The mobile device 210 is disposed on the middle floor, with a vertical position h in the z direction. The second access point 290b is disposed on the top floor, with a vertical position 2h in the z direction. There is no access point 290 disposed on the same floor as the mobile device 210.

The signal transmitted between the first access point 290a and the mobile device 210 experiences an observed Doppler shift of Δf1 due to the movement of the mobile device 210. The signal transmitted between the second access point 290b and the mobile device 210 experiences an observed Doppler shift of Δf2 due to the movement of the mobile device 210.

In the example shown in FIG. 8, the location system 700 comprises a server 702. The server 702 is coupled to a plurality of access points 290a, 290b by a wired or wireless connection. For example, the server 702 is coupled to the access points 290a, 290b by an Ethernet cable or a patch cable. Alternatively, the server 702 may be coupled to the access points 290a, 290 by a wireless network standard such as Bluetooth™, Wi-Fi, Wireless Ethernet, etc.

Here, the access points transmit horizontal position information, e1 and e2 to the server 702. In some embodiments, e1 may be transmitted to the server 702 directly from the mobile device 210. The server 702 then calculates the change in horizontal position of the mobile device 210 using the horizontal position information, and the expected Doppler shift is calculated for the mobile device 210. The server 702 then calculates Δf1 and Δf2 for each of the first and second access points 290a, 290b and compares the two values with the expected Doppler shift. Given that the vertical position information of the two access points 290a, 290b is known, the server 702 can infer the vertical position of the mobile device 210 based on the determination that it is not on the same floor as either of the access points 290a, 290b. This is useful in a collaborative network environment, where a plurality of network owners have subscribed to the location system. For example, in a retail complex, two stores may have access points 290 coupled to a server, but a third store may not have an access point 290.

Also in the embodiment shown in FIG. 8, the server 702 is in communication with a terminal device 704, such as a computer monitor or television. The server 702 and the terminal device 704 may be electrically coupled by a wired or a wireless connection. The server 702 and/or the terminal device 704 may be coupled to a plurality of networks of access points 290. This is useful for example in a shopping centre having an information kiosk for locating lost children having mobile devices 210, or for locating a climber from a base camp in an outdoor environment.

Although only two access points 290 are shown coupled to the server 702 in FIG. 8, it should be noted that it is within the scope of the present specification that one or more than two access points 290 may be coupled to the same server 702.

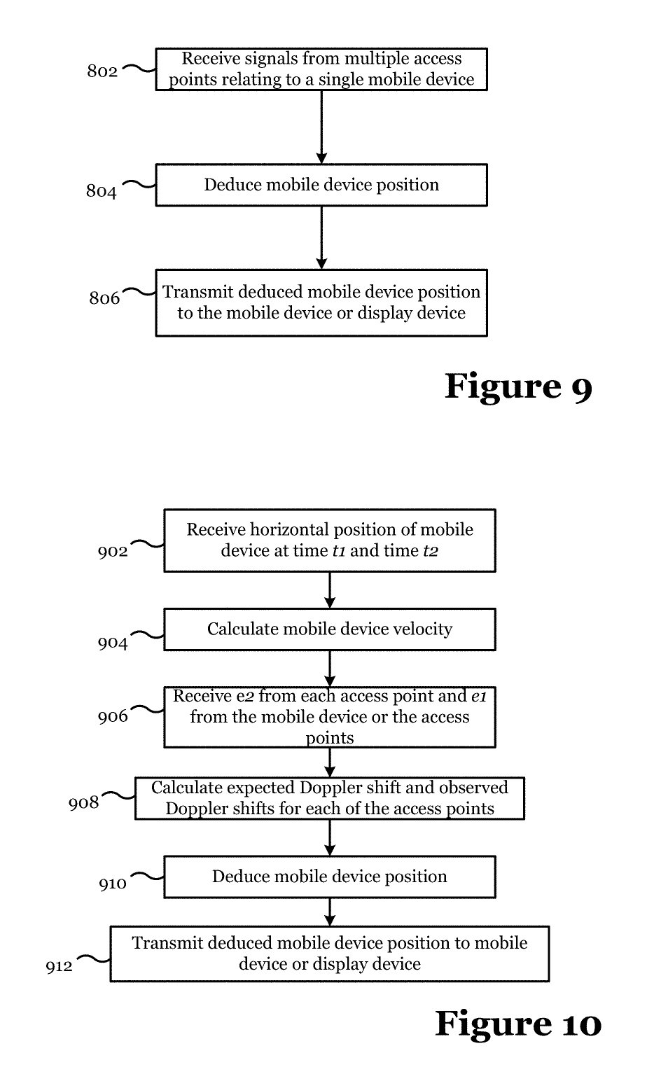

Processes carried out by the server 702 according to aspects of the present specification will now be described with reference to FIGS. 9 and 10. In FIG. 9, most of the calculation steps are carried out by the access points 290. In step 802, the server 702 receives a signal from a plurality of access points 290. Each signal includes information including vertical position information of the mobile device 210, calculated according to process B described with reference to FIG. 6. The information in the signal further includes an identifier for identifying the mobile device 210. The information in the signal further includes an identifier for the associated access point 290. The identifiers are, for example, a MAC address, IMEI or telephone number. The server 702 may use the identifier of the access point 290 to determine the vertical position of the access point 290 using a lookup table stored in memory. Alternatively, the vertical position of the access point 290 is transmitted in the respective signal.

In step 804, the server 702 uses the known vertical position of each access point 290 and the received vertical position information of the mobile device 210 to deduce the vertical position of the mobile device 210. For example, the server 702 may receive three signals, each corresponding to one of three wireless access points. If the information in one of the signals includes vertical position information that indicates that the mobile device is on the same floor as the respective access point, the server 702 stores the vertical position information as a known vertical position. Alternatively, if none of the received signals include information indicating that the mobile device 210 is on the same floor as one of the access points 290, then the server 702 is able to infer which of the floors that the mobile device 210 is likely to be on.

In some embodiments, the server 702 is able to use the relative differences between the expected Doppler shift and the observed Doppler shifts to predict the vertical position of the mobile device 210. For example, the difference between the observed Doppler shift and expected Doppler shift may be greater at one access point than the other, even though in both cases the value is greater than the threshold for the mobile device 210 and access point 290 being at the same vertical position. The server 702 can then determine that the mobile device 210 is closer to one access point 290 than the other, and hence deduce its location using multiple access points 290.

In step 806, the vertical position of the mobile device 210 is transmitted to the mobile device 210 or an external terminal device 704 for display. Alternatively, the server 702 is arranged to store the movement of the mobile device 210 for later analytics processing.

In FIG. 10, the server 702 is configured to carry out many of the processing steps shown in FIG. 6. In other words, the access points 290 are arranged to transmit the information necessary for the server 702 to calculate observed Doppler shift for each access point 290, and consequently calculate the vertical position of the mobile device.

In step 902, the server 702 receives the horizontal position of a mobile device 210 at a first time t1, and the horizontal position of the mobile device at a second time t2. The horizontal position may be received from the mobile device 210, from at least one access point 290, or from an external source. The server 702 also receives an identifier for identifying the mobile device. The identifier is, for example, a MAC address, IMEI or telephone number.

In step 904, the server 702 calculates the horizontal velocity of the mobile device, and the direction of travel.

In step 906, the server 702 receives the difference between the received signal frequency and the carrier frequency from either the mobile device 210 or the at least one access point 290, and the difference between the transmitted signal frequency and the carrier frequency from the at least one access point 290.

In step 908, the server 702 calculates the expected Doppler shift and observed Doppler shifts for each of the access points 290 according to the method described with reference to steps 604, 610 and 612 in FIG. 6.

In step 910, the server 702 compares the expected Doppler shift with the observed Doppler shift for each access point 290, to determine whether the mobile device 210 is at the same vertical position as any of the access points 290. The server 702 uses the amplitude of the differences in observed and expected Doppler shift to deduce the vertical position of the mobile device 210.

In other words, if the difference between the expected Doppler shift and the observed Doppler shift for a first access point 290a is greater than the difference between the expected Doppler shift and the observed Doppler shift for a second access point 290b, the server 702 is able to determine that the mobile device 210 is closer to the second access point 290b than the first access point 290a. The server 702 may use a received identifier of each access point 290 to determine the vertical position of the access point 290 using a lookup table stored in memory. Alternatively, each access point 290 may transmit its vertical position to the server 702.

In step 912, the server 702 transmits the deduced mobile device position to the mobile device 210 or a terminal device 704. Alternatively, the server 702 may store the deduced position for later processing.

It would be readily understood that steps 902 to 908 can be carried out in an order different to the order shown in FIG. 10 without departing from the scope of the specification.

In embodiments described herein, the access point 290 is used to determine the horizontal position of the mobile device 210 (i.e. the position of the mobile device 210 on the XY plane). In other embodiments, however, the mobile device 210 is controlled to transmit horizontal position information to the access point 290 or server 702.

While embodiments described herein describe the invention being implemented using Wi-Fi, it would be readily appreciated by the skilled person that the invention could be implemented using any RF band with a time division duplex profile. In other words, where the uplink and downlink (i.e. mobile device and access point) communicate via the same frequency band, the observed Doppler shift can be calculated.

Embodiments of the present disclosure may be implemented in software, hardware, application logic or a combination of software, hardware and application logic. The software, application logic and/or hardware may reside on memory, or any computer media. In an example embodiment, the application logic, software or an instruction set is maintained on any one of various conventional computer-readable media. In the context of this document, a “computer-readable medium” may be any media or means that can contain, store, communicate, propagate or transport the instructions for use by or in connection with an instruction execution system, apparatus, or device, such as a computer.

A computer-readable medium may comprise a computer-readable storage medium that may be any tangible media or means that can contain or store the instructions for use by or in connection with an instruction execution system, apparatus, or device, such as a computer as defined previously.

According to various embodiments of the previous aspect of the present disclosure, the computer program according to any of the above aspects, may be implemented in a computer program product comprising a tangible computer-readable medium bearing computer program code embodied therein which can be used with the processor for the implementation of the functions described above.

Reference to “computer-readable storage medium”, “computer program product”, “tangibly embodied computer program” etc., or a “processor” or “processing circuit” etc. should be understood to encompass not only computers having differing architectures such as single/multi processor architectures and sequencers/parallel architectures, but also specialised circuits such as field programmable gate arrays FPGA, application specify circuits ASIC, signal processing devices and other devices. References to computer program, instructions, code etc. should be understood to express software for a programmable processor firmware such as the programmable content of a hardware device as instructions for a processor or configured or configuration settings for a fixed function device, gate array, programmable logic device, etc.

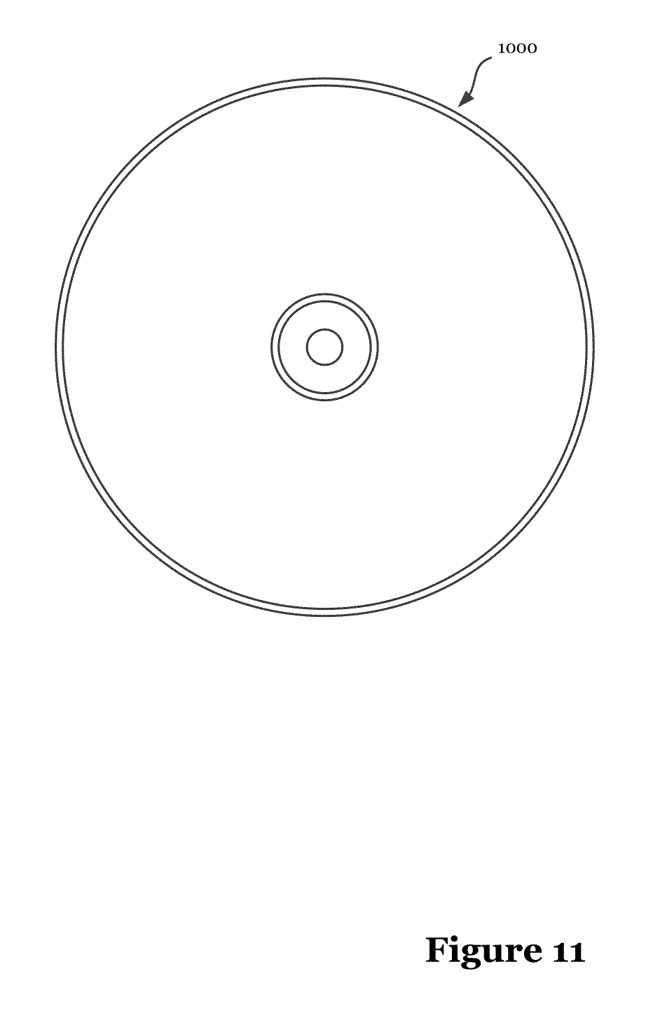

By way of example, and not limitation, such “computer-readable storage medium” may mean a non-transitory computer-readable storage medium which may comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. An exemplary non-transitory computer-readable storage medium 1000 is shown in FIG. 11, in the form of an optical storage disk such as a CD. Also, any connection is properly termed a “computer-readable medium”. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that “computer-readable storage medium” and data storage media do not include connections, carrier waves, signals, or other transient media, but are instead directed to non-transient, tangible storage media. Disk and disc, as used herein, include compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of “computer-readable medium”.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules. Also, the techniques could be fully implemented in one or more circuits or logic elements.

The computer readable instructions/program code may be pre-programmed into the processor 211/271. Alternatively, the computer readable instructions may arrive at the processor 211/271 via an electromagnetic carrier signal or may be copied from a physical entity 1000 such as a computer program product, a memory device or a record medium such as a CD-ROM or DVD an example of which is illustrated in FIG. 11. The computer readable instructions may provide the logic and routines that enables the mobile device 210, access point 290 and server 702 to perform the functionality described above. The combination of computer-readable instructions stored on memory (of any of the types described above) may be referred to as a computer program product. In general, references to computer program, instructions, code etc. should be understood to express software for a programmable processor firmware such as the programmable content of a hardware device as instructions for a processor or configured or configuration settings for a fixed function device, gate array, programmable logic device, etc.

If desired, the different steps discussed herein may be performed in a different order and/or concurrently with each other. Furthermore, if desired, one or more of the above-described steps may be optional or may be combined.

Although various aspects of the present disclosure are set out in the independent claims, other aspects of the present disclosure comprise other combinations of features from the described embodiments and/or the dependent claims with the features of the independent claims, and not solely the combinations explicitly set out in the claims.

1. A method comprising:
calculating a horizontal velocity and direction of horizontal movement of a mobile device in communication with at least one wireless access point;
calculating an observed Doppler shift in a signal transmitted between the mobile device and the at least one wireless access point;
calculating an expected Doppler shift in the transmitted signal based on a carrier frequency, the horizontal velocity and direction of horizontal movement; and
determining a vertical position of the mobile device based on the expected Doppler shift and the observed Doppler shift.

2. The method according to claim 1, wherein calculating the observed Doppler shift comprises:
measuring the frequency of a signal received by the mobile device from the wireless access point;
calculating a first difference between the frequency of the signal received by the mobile device and the frequency of a signal transmitted by the mobile device;
measuring the frequency of a signal transmitted by the at least one wireless access point;
calculating a second difference between the frequency of the signal transmitted by the at least one wireless access point and the frequency of a signal received by the wireless access point from the mobile device; and
calculating the observed Doppler shift based on the first difference and the second difference.

3. The method according to claim 2, further comprising:
calculating the observed Doppler shift according to the equation:
Δf=−(e₁+e₂)/2,
wherein Δf is the observed Doppler shift, e₁ is the first difference, and e₂ is the second difference.

4. The method according to claim 1, wherein a or the carrier frequency is one of 2.4 GHz and 5 GHz.

5. The method according to claim 1, comprising:
calculating the observed Doppler shift in a plurality of signals transmitted between the mobile device and a plurality of wireless access points, wherein each signal is associated with a corresponding one of the plurality of wireless access points; and
deducing the position of the mobile device based on the expected Doppler shift and the plurality of observed Doppler shifts.

6. The method according to claim 5, comprising:
calculating the observed Doppler shifts at each of the corresponding wireless access points;
transmitting the Doppler shift observed at the plurality of wireless access points to a server; and
calculating the vertical position of the mobile device at the server.

7. The method according to any one of claim 1, comprising:
calculating the vertical position of the mobile device at the at least one wireless access point; and
transmitting the calculated vertical position to at least one of a server, mobile device, and display apparatus.

8. The method according to claim 7, comprising receiving an identifier of the mobile device, and transmitting the calculated vertical position to the mobile device based on the identifier.

9. The method according to claim 1, comprising converting the calculated vertical position of the mobile device to a floor number.

10. The method according to claim 1, comprising displaying the vertical position of the mobile device.

11. The method according to claim 1, wherein the mobile device is determined to be at the same vertical position as the at least one wireless access point if the observed Doppler shift is greater than a threshold, and wherein the mobile device is determined to be at a different vertical position to the wireless access point if the observed Doppler shift is less than the threshold,
wherein the threshold is based on the expected Doppler shift.

12. A computer-readable storage medium having computer-readable code stored thereon, the computer-readable code, when executed by at least one processor, causing performance of:
calculating a horizontal velocity and direction of horizontal movement of a mobile device in communication with at least one wireless access point;
calculating an observed Doppler shift in a signal transmitted between the mobile device and the at least one wireless access point;
calculating an expected Doppler shift in the transmitted signal based on a carrier frequency, the horizontal velocity and direction of horizontal movement; and
determining a vertical position of the mobile device based on the expected Doppler shift and the observed Doppler shift.

13. The computer-readable storage medium according to claim 12 having computer-readable code stored thereon, the computer-readable code, when executed by at least one processor, causing performance of:
measuring the frequency of a signal received by the mobile device from the wireless access point;
calculating a first difference between the frequency of the signal received by the mobile device and the frequency of a signal transmitted by the mobile device;
measuring the frequency of a signal transmitted by the at least one wireless access point;
calculating a second difference between the frequency of the signal transmitted by the at least one wireless access point and the frequency of a signal received by the wireless access point from the mobile device; and
calculating the observed Doppler shift based on the first difference and the second difference.

14. The computer-readable storage medium according to claim 13 having computer-readable code stored thereon, the computer-readable code, when executed by at least one processor, causing performance of:
calculating the observed Doppler shift according to the equation:
Δf=−(e₁+e₂)/2,
wherein Δf is the observed Doppler shift, e₁ is the first difference, and e₂ is the second difference.

15. The computer-readable storage medium according to claim 12, wherein the mobile device is determined to be at the same vertical position as the at least one wireless access point if the observed Doppler shift is greater than a threshold, and wherein the mobile device is determined to be at a different vertical position to the wireless access point if the observed Doppler shift is less than the threshold,
wherein the threshold is based on the expected Doppler shift.

16. An apparatus comprising:
at least one computer processor; and
at least one memory having computer-readable instructions stored thereon, the computer-readable instructions when executed by the at least one processor causing the apparatus at least to:
obtain a horizontal velocity and direction of horizontal movement of a mobile device;
calculate an observed Doppler shift in a signal transmitted between the mobile device and the apparatus;
calculate an expected Doppler shift in the transmitted signal based on the horizontal velocity and direction of horizontal movement; and
determine a vertical position of the mobile device based on the expected Doppler shift and the observed Doppler shift.

17. The apparatus according to claim 16, the computer-readable instructions causing the apparatus at least to:
receive a first difference in frequency between the signal received by the mobile device and a signal transmitted by the mobile device;
measure a frequency of a signal received by the apparatus from the mobile device;
calculate a second difference between the frequency of the signal received by the apparatus and the frequency of a signal transmitted by the apparatus; and
calculate the observed Doppler shift based on the difference between the first difference and the second difference.

18. The apparatus according to claim 17, the computer-readable instructions causing the apparatus at least to:
calculate the observed Doppler shift according to the equation:
Δf=−(e₁+e₂)/2,
wherein Δf is the observed Doppler shift, e₁ is the first difference, and e₂ is the second difference.

19. The apparatus according to claim 16, the computer-readable instructions causing the apparatus at least to:
determine the mobile device to be at the same vertical position as the apparatus if the observed Doppler shift is greater than a threshold, and determine the mobile device to be at a different vertical position to the apparatus if the observed Doppler shift is less than a the threshold, wherein the threshold is based on the expected Doppler shift.

20. The apparatus according to claim 16, wherein the apparatus is an IEEE 802.11 compliant access point.
